(19) United States
(12) Patent Application Publication
(10) Pub. No.: US 2018/0086286 A1
(43) Pub. Date: Mar. 29, 2018

(54) Door Guard for an Automobile

(71) Applicant: Denia Elamparo, Wailuku, HI (US)

(72) Inventor: Denia Elamparo, Wailuku, HI (US)

(21) Appl. No.: 15/277,806

(22) Filed: Sep. 27, 2016

(51) Int. Cl. B60R 13/04

(52) U.S. Cl. CPC B60R 13/043

(57) ABSTRACT

The invention relates to a door guard for protecting exterior surface of an automobile door. The door guard is an elongated body made from a single piece of plastic. The body can have a length of between two to six inches, a width of between two to five inches, and a thickness of between a quarter and three inches. The door guard further includes a plastic clip formed on a surface of the guard 20. The clip has a hooked shape that can be slideably mateable with a flange of an automobile door so that the length of the body extends along the length of the door.

### TECHNICAL FIELD

The present invention relates to a door guard for mounting to an automobile door for the purpose of preventing scratches and dings that can occur when opening the automobile door and, more specifically, to an integrated plastic molding door guard with insulating member and integrating clip member.

### BACKGROUND

Automobile door guards are known in the industry and are typically applied to a door's rear flange in order to prevent the door from scratching or denting other objects, such as an adjacent automobile, and the automobile door itself from damage when opening the door. These door guards are typically applied along the door's flange at the rear of the door. Typically these door guards are applied using adhesives or plastic molding either installed during manufacture or after market. However, these door guards are typically just functional and once installed may not be that easy to remove and re-install. In addition, they are often not that discrete and easily manageable. In other words, removing, storing, and re-installing is not always easily done. The point being is that although the user may have a need for the door guard, the user may not always desire the door guard be present, especially when not needed. As such, there is a need for a door guard that is functional, discrete, easy to install, easy to remove, and cheap to produce.

### SUMMARY

The objectives of the invention are achieved by providing a door guard with an elongated body made from a single piece of plastic. The body can have a length of between two to six inches, a width of between two to five inches, and a thickness of between a quarter and three inches. The door guard further includes a plastic clip formed on a surface of the guard. The clip has a hooked shape that can be slideably mateable with a flange of an automobile door so that the length of the body extends along the length of the door.

### BRIEF DESCRIPTION OF THE DRAWINGS

FIG. 1 is perspective view of an automobile car door with a door guard applied along the rear flange of the door according to an embodiment of the invention.

FIG. 2 is a perspective view of a door guard according to an embodiment of the invention.

### DETAILED DESCRIPTION

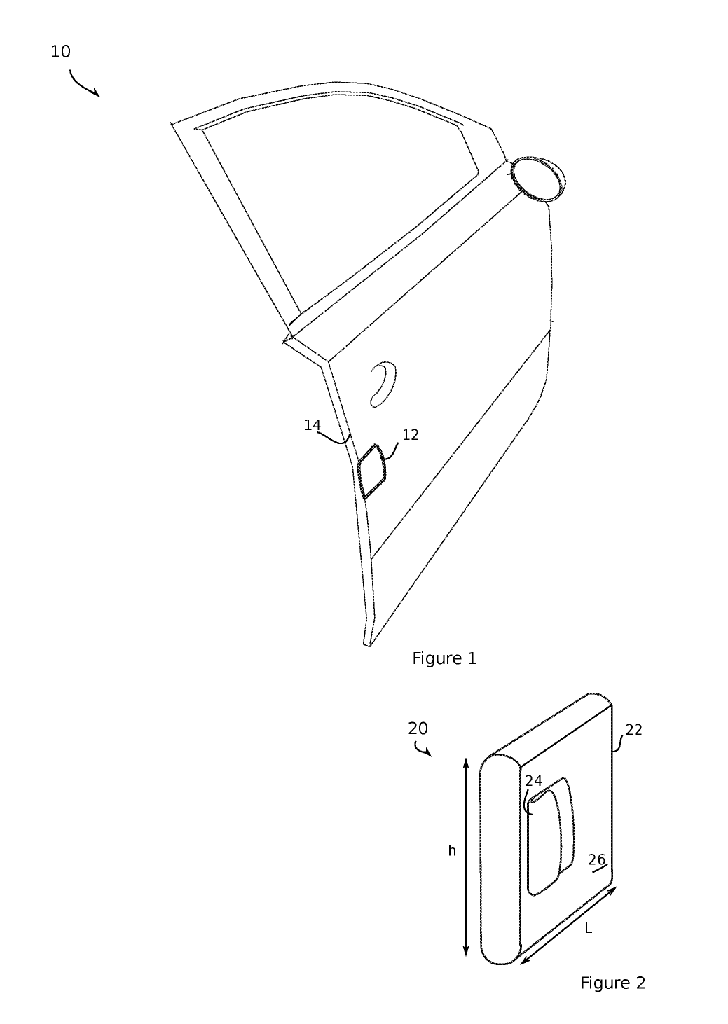

Referring to FIG. 1, illustrated is an automobile door that includes a door guard applied along the door's rear flange and is denoted generally 10. The automobile door 10 includes a door guard 12 that can be applied along a rear flange 14 of the automobile door 10.

Referring now to FIG. 2, illustrated is a perspective view of the door guard of FIG. 1 and is denoted generally as 20. The door guard 20 has an elongated body 22, as illustrated, made from a single piece of plastic, e.g. using injection molding processes. The body 22 has a length of about two to six inches, a width or height of about two to five inches, and a thickness of between a quarter and three quarter inches. These dimensions make the guard 20 effective in preventing scratches and dings when the door is opened but also keeps the guard discrete and manageable. The door guard 20 further includes a plastic clip 24 formed on a surface 26 of the guard 20. The clip 24 has a hooked shape that can be slideably mateable with the flange 14 of the automobile door 10 so that when applied the length of the door guard 20 extends along the length of the automobile door 10.

Thus, While there have been shown and described and pointed out fundamental novel features of the invention as applied to a preferred embodiment thereof, it will be under stood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A door guard for use with a flange of an automobile door, the guard comprising:
a singular elongated body of a predetermined length, width, and thickness made from plastic that includes an internal side and an external side, the internal side having a flexible plastic clip formed on an end of the surface of the internal side, the flexible plastic clip slidably mateable with the flange.

2. The door guard of claim 1 wherein the length of the elongated body is between two to six inches, the width of the elongated body is between two to five inches, and the thickness of the elongated body is between a quarter and three quarter inches.
